(19) United States
(12) Patent Application Publication
(10) Pub. No.: US 2008/0241546 A1
(43) Pub. Date: Oct. 2, 2008

(54) MACHINING FEATURES IN LASER SHOCK PEENED REGIONS

(75) Inventors: Robert David McClain, Cincinnati, OH (US); Brian Michael Davis, West Chester, OH (US); Seetha Ramaiah Mannava, Cincinnati, OH (US)

Correspondence Address: Steven J. Rosen, 4729 Cornell Rd., Cincinnati, OH, 45241, US

(73) Assignee: GENERAL ELECTRIC COMPANY, Schenectady, NY (US)

(21) Appl. No.: 11/694,214

(22) Filed: Mar. 30, 2007

(51) Int. Cl. B23K 26/00

(52) U.S. Cl. 428/409; 219/121.85

(57) ABSTRACT

A method for laser shock peening an article includes laser shock peening the article forming at least one pre-stressed region having deep compressive residual stresses imparted by the laser shock peening and machining a feature into article in the pre-stressed region after the laser shock peening. The feature may be machined entirely in the pre-stressed region. The pre-stressed region may extend completely between oppositely spaced apart sides of the article with the feature machined entirely through the pre-stressed region and completely between and through the spaced apart outer and inner sides. The feature may be a hole or a scallop. The article may be an arcuate wall having a radius of curvature and the feature includes a centerline and is machined into wall with the centerline substantially parallel to the radius of curvature. The hole or scallop may have a curved sharp edge.

### BACKGROUND OF THE INVENTION

This invention relates to machining features and laser shock peening and, more particularly, to methods and articles of manufacture having features machined into laser shock peened regions.

Laser shock peening or laser shock processing, as it is also referred to, is a process for producing a region of deep compressive residual stresses imparted by laser shock peening a surface area of an article. Laser shock peening typically uses one or more radiation pulses from high energy, about 50 joules or more, pulsed laser beams to produce an intense shockwave at the surface of an article similar to methods disclosed in U.S. Pat. No. 3,850,698 entitled “Altering Material Properties”; U.S. Pat. No. 4,401,477 entitled “Laser Shock Processing”; and U.S. Pat. No. 5,131,957 entitled “Material Properties”. The use of low energy laser beams is disclosed in U.S. Pat. No. 5,932,120, entitled “Laser Shock Peening Using Low Energy Laser”, which issued Aug. 3, 1999 and is assigned to the present assignee of this patent. Laser shock peening, as understood in the art and as used herein, means utilizing a pulsed laser beam from a laser beam source to produce a strong localized compressive force on a portion of a surface by producing an explosive force at the impingement point of the laser beam by an instantaneous ablation or vaporization of a thin layer of that surface or of a coating (such as tape or paint) on that surface which forms a plasma.

Laser shock peening is being developed for many applications in the gas turbine engine field, some of which are disclosed in the following U.S. Pat. Nos. 5,756,965 entitled “On The Fly Laser Shock Peening”; 5,591,009 entitled “Laser Shock Peened Gas Turbine Engine Fan Blade Edges”; 5,531,570 entitled “Distortion Control For Laser Shock Peened Gas Turbine Engine Compressor Blade Edges”; 5,492,447 entitled “Laser Shock Peened Rotor Components For Turbomachinery”; 5,674,329 entitled “Adhesive Tape Covered Laser Shock Peening”; and 5,674,328 entitled “Dry Tape Covered Laser Shock Peening”, all of which are assigned to the present Assignee.

Laser shock peening has been utilized to create a compressively stressed protective layer at the outer surface of an article which is known to considerably increase the resistance of the article to fatigue failure as disclosed in U.S. Pat. No. 4,937,421 entitled “Laser Peening System and Method”. These methods typically employ a curtain of water flowed over the article or some other method to provide a plasma confining medium. This medium enables the plasma to rapidly achieve shockwave pressures that produce the plastic deformation and associated residual stress patterns that constitute the LSP effect. The curtain of water provides a confining medium, to confine and redirect the process generated shockwaves into the bulk of the material of a component being LSP'd, to create the beneficial compressive residual stresses.

The pressure pulse from the rapidly expanding plasma imparts a traveling shockwave into the component. This compressive shockwave initiated by the laser pulse results in deep plastic compressive strains in the component. These plastic strains produce residual stresses consistent with the dynamic modulus of the material. The many useful benefits of laser shock peened residual compressive stresses in engineered components have been well documented and patented, including the improvement on fatigue capability.

The laser shock process (LSP) imparts deep compressive stresses in the article by generating a pressure pulse that travels into the component. The pressure pulse can be reflected from internal structures as tensile waves. Opposing waves and single waves can have sufficient energy in this reflected wave to rupture the component internally. The resulting crack or rupture is referred to or termed “delamination”. One method proposed in the past to avoid or minimize delaminations is offsetting two opposing laser beams/waves laterally through the component. See U.S. Pat. No. 6,570,126 entitled “Simultaneous Offset Dual Sided Laser Shock Peening Using Low Energy Laser Beams” and U.S. Pat. No. 6,570,125 entitled “Simultaneous Offset Dual Sided Laser Shock Peening With Oblique Angle Laser Beams”. Alternatively, striking the component or part from one side at a time has been suggested.

It is desirable to extend fatigue capability of components with holes and other machined features under stress, particularly where the hole represents the life-limiting location of the component (e.g. disk/shaft oil drain holes). This enables continued service of the component and extends retirement of expensive engine parts. Currently, holes are placed through the walls of high-speed turbomachinery to allow egress of fluids, such as sump oil, to vent into the engine gaspath and/or to vent a dead air cavity, so as to equalize pressures. These holes are oriented and shaped to minimize the stress concentration (Kt) that the hole presents to the prevailing stress field (often hoop stress). The stress concentration for a round hole under a simple hoop stress is 3. Often, additional design and manufacturing expense are incurred to shape the hole and present the most optimal shape to the dominant stress component to reduce the Kt as mentioned above. Results of these efforts, however, do not generally reduce the Kt below 2. This level of stress concentration significantly reduces low cycle fatigue (LCF) and residual crack life (RCL) capability of the component and often represents the life-limiting location of the component, driving retirement of the part from service.

The imposition of purposeful residual stress has been applied, primarily in the aircraft industry, to fuselage holes in aluminum via split sleeve cold expansion (SSCE). However, this process is limited in the geometry of hole it can treat and the process is difficult to control to provide the required consistency in order to realize a lifing benefit. It is known to laser shock peen areas already containing holes, i.e., subsequent to machining of the holes.

It is desirable to further extend fatigue capability of components with holes and other machined features under stress, particularly where these features represent the life-limiting location of the component (e.g. disk/shaft oil drain holes).

### SUMMARY OF THE INVENTION

An article and method for laser shock peening. The method includes laser shock peening the article to form pre-stressed regions with deep compressive residual stresses imparted by the laser shock peening extending into the article and then machining features, such as holes or scallops, into the pre-stressed regions after the laser shock peening. The method includes laser shock peening a laser shock peening surface of the article and forming at least one pre-stressed region having deep compressive residual stresses imparted by the laser shock peening. The pre-stressed region extends into the article from a laser shock peened surface formed by the laser shock peening. A feature is machined into article in the pre-stressed region after the laser shock peening.

The feature may be machined entirely in the pre-stressed region after the laser shock peening. The pre-stressed region may extend completely between oppositely spaced apart sides of the article. The feature may be machined entirely through the pre-stressed region and completely between and through the spaced apart outer and inner sides of the article after the laser shock peening. The feature may be a hole or a scallop. The laser shock may be performed on the laser shock peening surface on an arcuate wall of the article, the wall having a radius of curvature. The feature may include a centerline and may be machined into wall with the centerline substantially parallel to the radius of curvature. The feature may be a hole or a scallop having a curved sharp edge.

### BRIEF DESCRIPTION OF THE DRAWINGS

FIG. 1 is a perspective view illustration of a gas turbine engine shaft with a drain hole exemplifying an article with a feature machined into a laser shock peened region.

FIG. 2 is a cross-sectional view illustration of the laser shock peened region with the hole drilled therethrough of the article illustrated in FIG. 1.

FIG. 3 is a cross-sectional view illustration of a gas turbine engine disk arm with a drain hole exemplifying an article with a feature machined into a laser shock peened region.

FIG. 4 is a cross-sectional view illustration of a gas turbine engine ring with scallops machined into laser shock peened regions of the ring.

FIG. 5 is a flow chart illustrating laser shock peening prior to machining a feature in a laser shock peened region.

FIG. 6 is a schematic illustration of laser shock peening the article illustrated in FIG. 1 prior to machining the hole.

### DETAILED DESCRIPTION OF THE INVENTION

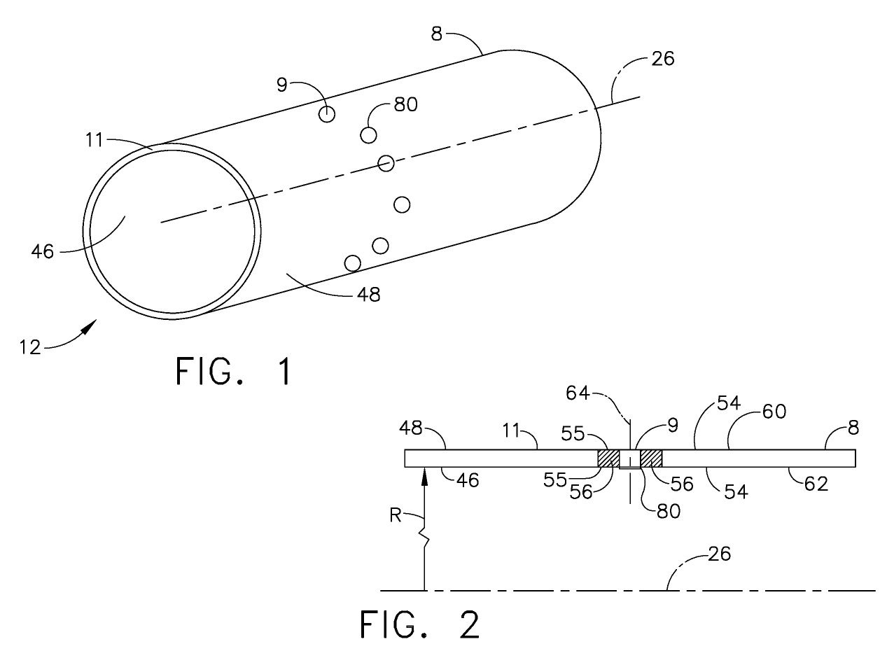

Illustrated in FIGS. 1 and 2 is a gas turbine engine annular shaft 8, circumscribed about an axis 26, exemplifying an article having laser shock peened patches or laser shock peened surfaces 55, pre-stressed regions 56 having deep compressive residual stresses imparted by a laser shock peening (LSP) process extending into and through the shaft from the laser shock peened surfaces 55, and drain holes 9 drilled or machined through a wall 11 of the shaft 8 subsequent to the laser shock peening. Note that the holes have centerlines 64 that are substantially parallel to a radius of curvature R of the wall 11. The embodiment of the pre-stressed regions 56 illustrated herein extend completely through the shaft between radially spaced apart outer and inner sides 60, 62 of the wall 11 of the shaft 8. Other embodiments need not be laser shock peened completely through the article. The method may also be used on articles having other than annular or curved walls.

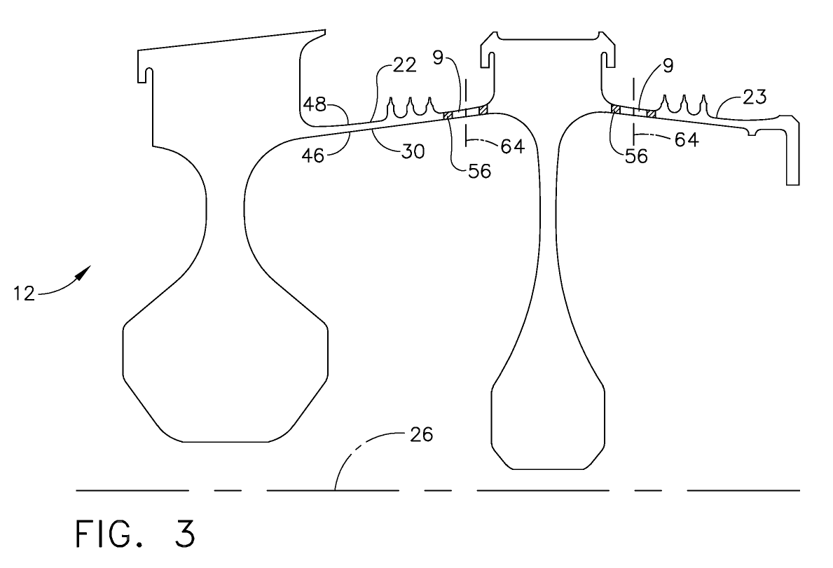

Illustrated in FIG. 3 is a gas turbine engine annular turbine disk assembly 30 with annular forwardly and aftwardly extending arms 22, 23 circumscribed about an axis 26. Drain holes 9 drilled or machined through the aftwardly extending arm 23 subsequent to laser shock peening further illustrate holes drilled or machined into laser shock peened patches or laser shock peened surfaces 55 and the pre-stressed regions 56 having deep compressive residual stresses imparted by the laser shock peening (LSP) process subsequent to the laser shock peening. Note that the holes have centerlines 64 that are substantially parallel to a radius of curvature R of the annular turbine disk assembly 30 and the annular forwardly and aftwardly extending arms 22, 23.

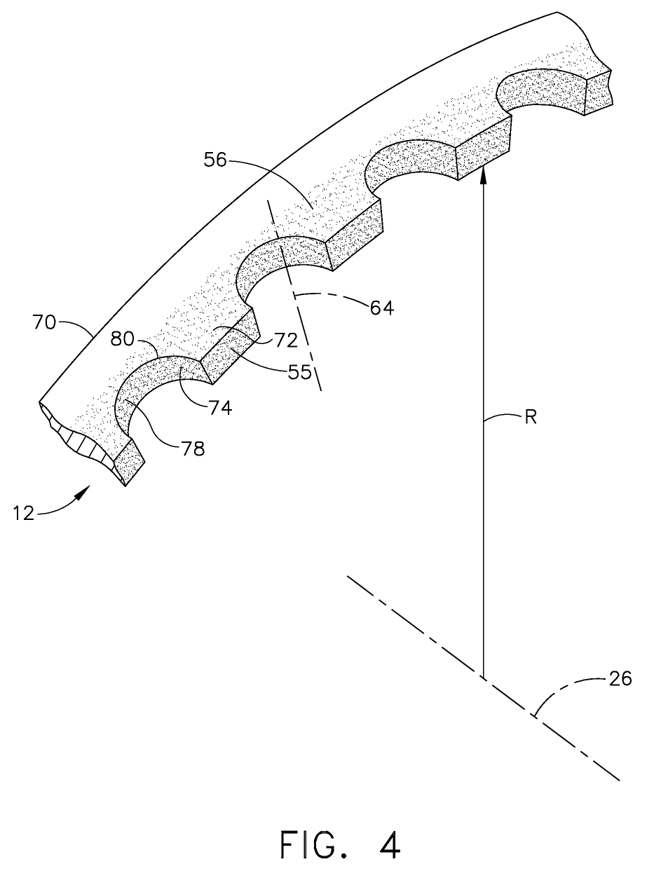

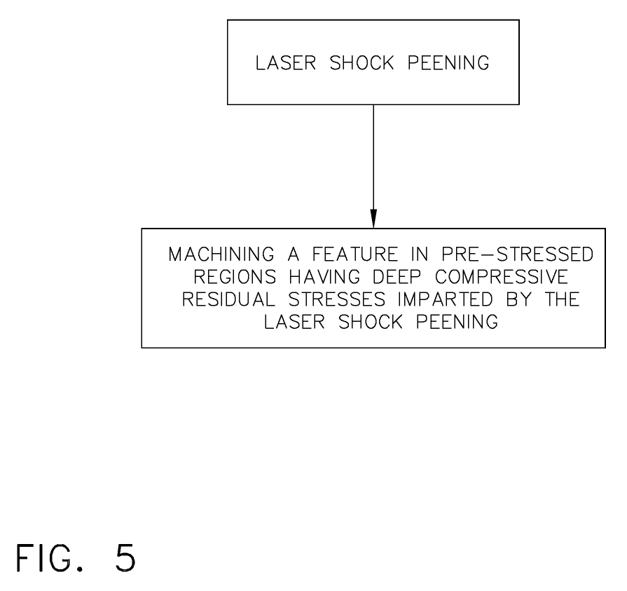

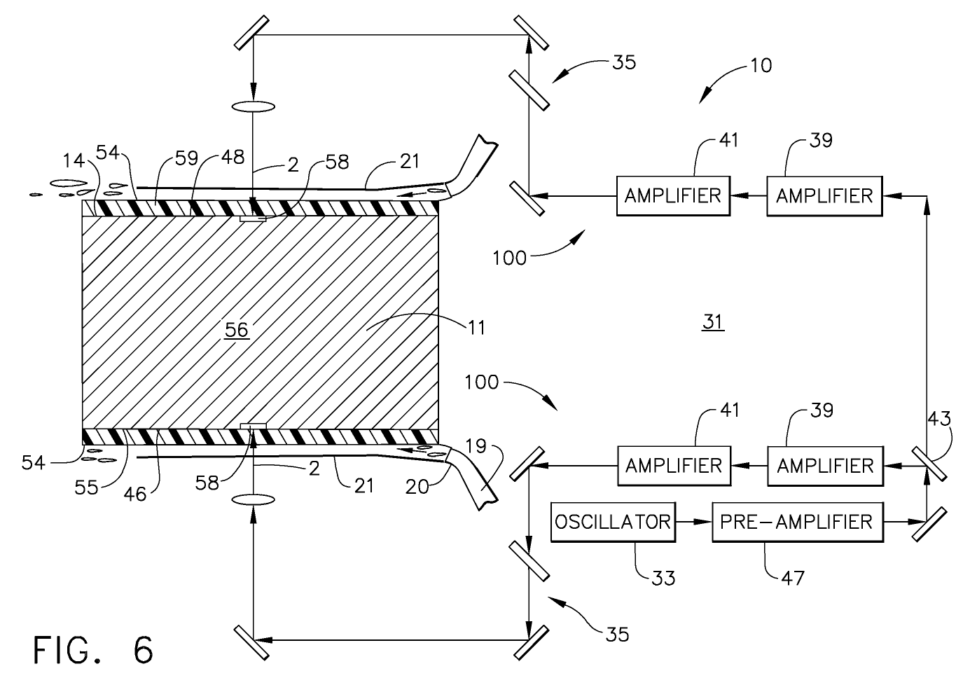

Illustrated in FIG. 4 is a gas turbine engine ring 70 circumscribed about a centerline 26 and having an annular scalloped edge 72. Scallops 74 are machined into pre-stressed regions 56 having deep compressive residual stresses imparted by laser shock peening. The scallops 74 are machined into the ring subsequent to the laser shock peening. Note that the scallops 74 have circular or curved portions 78 with centerlines 64 that are substantially parallel to a radius of curvature R of the ring 70. The holes 9 and the scallops 74 have curved sharp edges 80. These sharp edges are stronger and more robust and more resistant to cyclic fatigue because they are machined into the laser shocked pre-stressed regions 56 subsequent to the laser shock peening. Laser shock peening prior to machining these features helps resist or prevent damage to the feature during machining as well as during engine operation or vibrations. Note that the walls 11 are arcuate.

It is well known to use laser shock peening to counter possible fatigue failure of portions of an article. Laser shock peening of holes subsequent to machining of these features is disclosed in several patents. Areas around holes 9, for instance, are subject to a significant tensile stress field due to centrifugal forces generated by the shaft 8 rotating during engine operation. The shaft 8 is also subject to vibrations generated during engine operation and the holes 9 operate as high cycle fatigue stress risers producing additional stress concentrations around them. Typically, laser shock peening surfaces 54 on one or both sides of an article are laser shock peened producing laser shock peened patches or laser shock peened surfaces 55 and pre-stressed regions 56 having deep compressive residual stresses imparted by a laser shock peening (LSP) process extending into the article from the laser shock peened surfaces 55.

In the past, an area and region containing the hole is laser shock peened after the feature such as a hole is machined into the article. We have found that this can distort the feature and in particular it can distort sharp edges such as those found at entrances to holes. Sharp edges of such features may also be subject to delamination due to laser shock peening. Distortion of a hole, for example, might manifest itself in the form of the hole being out-of-round, off-axis, or both due to the residual stresses inherent in the LSP process. Surface irregularity might be introduced thus negatively affecting surface integrity e.g. surface profile tolerance and surface finish.

Diminished surface integrity would probably require post-LSP rework. While the LSP naturally provides a fatigue benefit on the surface due to its compressive residual stress, rolling of edges around holes or other features such as scallops, for example, would be expected (as it certainly happens with conventional shot peening) which would actually be a detriment to feature life. Poor surface finish/profile would also lead to problems with mate-up of adjacent parts, an example being a bolted flange. If the flange surface is rough and/or out-of-profile, the bolthead would not rest squarely on the flange face and would thus induce bending of the bolt, flange, or both etc. Machining of the bolthole and counterbore after LSP would insure that the feature of interest is as-desired, while still receiving a benefit from the LSP.

In order to avoid distortion of the features and their sharp edges and to avoid rework of the features the method described above for forming holes and other features, particularly features having sharp edges, was developed. This method illustrated in a flow chart in FIG. 5 includes first laser shock peening at least a portion of the article 12 over at least one of the laser shock peening surface 54. This creates pre-stressed regions 56 having deep compressive residual stresses imparted by the laser shock peening extending into the article from laser shock peened surfaces 55 formed by the laser shock peening. This method further includes machining the feature, exemplified by the drain holes 9 and scallops 74 described above, into the article subsequent to the laser shock peening.

The method illustrated in the flow chart in FIG. 5 may be summarized as first laser shock peening and subsequently machining a feature in pre-stressed regions 56 having deep compressive residual stresses imparted by the laser shock peening. This method of machining features subsequent to laser shock peening can enhance producability over trying to LSP an existing feature. This is due to a desire of not wanting to miss the hole resulting in shooting the laser through the hole and hitting the opposed beam (assumes here double-sided processing) during manufacture. This is not an issue if hole or feature is machined after the laser shock peening step and reduces programming time and masking time as compared to laser shock peening subsequent to machining the feature.

The drain holes 9, illustrated in FIGS. 1 and 2, and the scallops 74 illustrated in FIG. 3 exemplify features machined into a laser shock peened region of an article subsequent to laser shock peening patches or laser shock peened surfaces 55 with the pre-stressed regions 56 having deep compressive residual stresses imparted by the laser shock peening extending into and as illustrated herein entirely through the article from the laser shock peened surfaces 55.

Illustrated in FIG. 5 is a schematic illustration of a laser shock peening system 10 that is used to laser shock peen articles exemplified by a section of the wall 11 of the shaft illustrated in FIGS. 1 and 2. A section of the wall 11 is illustrated with the laser shock peening surface 54 that is to be laser shock peened forming the laser shock peened surfaces 55. The laser shock peening system 10 includes a generator 31 having an oscillator 33 and a pre-amplifier and a beam splitter which feeds the pre-amplified laser beam into two beam optical transmission circuits and optics 35 that transmit and focus oppositely aimed laser beams 2 simultaneously on radially inner and outer sides 46, 48. The shaft 8 may be mounted in a fixture attached to a manipulator such as a five-axis computer numerically controlled (CNC) manipulator controlled by a CNC controller. The manipulator and the CNC controller can be used to continuously move and position the blade to provide laser shock peening “on the fly”. Robots may also be used. Laser shock peening may be done in a number of various ways using paint or tape as an ablative medium (see in particular U.S. Pat. No. 5,674,329 entitled “Adhesive Tape Covered Laser Shock Peening”).

A clear confining medium to cover the laser shock peening surface 54 is provided by a curtain of flowing water 21 supplied by a water nozzle 20 at the end of a water supply tube 19. The curtain of flowing water 21 is particular to the exemplary embodiment illustrated herein, however, other types of confining mediums may be used. The laser shock peening system 10 illustrated herein includes a laser beam apparatus including a generator 31 having an oscillator 33 and a pre-amplifier 47 and a beam splitter 43 which feeds the pre-amplified laser beam into two beam optical transmission circuits 100 each having a first and second amplifier 39, 41, respectively, and optics 35 which include optical elements that transmit and focus the laser beam 2 on the laser shock peening surface 54. A laser controller is used to modulate and fire the laser beam apparatus to fire the laser beam 2 on the bare laser shock peening surface 54 in a controlled manner. The CNC controller may be used to control the operation of the laser controller particularly as to when to fire the laser beams 2.

The laser beam shock induced deep compressive residual stresses in the compressive pre-stressed regions 56 are generally about 50-150 KPSI (Kilo Pounds per Square Inch) and extend to a depth of about 20-50 mils into the wall 11 from the laser shock peened surfaces 55. The laser beam shock induced deep compressive residual stresses are produced by repetitively firing a high energy laser beam 2 that is defocused plus or minus a few mils with respect to the laser shock peening surface 54. The laser beam 2 typically has a peak power density on the order of magnitude of a gigawatt/cm² and is fired with a curtain of flowing water 21 or other fluid that is flowed over the laser shock peening surface 54 or some other clear confining medium. The laser shock peening surface 54 may be bare or as illustrated herein may be coated with an ablative coating 59 such as paint or adhesive tape to form coated surfaces as disclosed in U.S. Pat. Nos. 5,674,329 and 5,674,328. The coating 59 provides an ablative medium over which the clear containment medium is placed, such as a fluid curtain such as a curtain of flowing water 21. During laser shock peening, the article 12 is moved while the stationary laser beams 2 are fired through curtains of flowing water 21, dispensed by water nozzles 20, on the laser shock peened surfaces 55. The laser shock peening process is used to form laser shock peened surface 55 from overlapping laser shock peened circular or otherwise shaped spots 58 on laser shock peening surface 54.

The coating or bare metal surface 14 is ablated generating plasma which results in shock waves on the surface of the material. These shock waves are redirected towards the laser shock peening surface 54 by the clear confining medium, illustrated herein as the curtain of flowing water 21, or confining layer to generate travelling shock waves (pressure waves) in the material below the laser shock peening surface 54. The amplitude and quantity of these shockwaves determine the depth and intensity of compressive stresses. The exemplary laser shock peening method illustrated herein simultaneously laser shock peens opposite sides of the article illustrated by the inner and outer sides 46, 48 of the wall 11. This method is also referred to as dual sided laser shock peening. Single sided laser shock peening may also be used to laser shock peen just one side of an article at a time. The compressive pre-stressed regions 56 may be completely formed in thinner articles or walls by laser shock peening just one side of the article so that the compressive pre-stressed regions fully extend between opposite sides of the article or wall. The method for machining features disclosed herein may also be used for features that don't extend completely through an article or wall. Again such features are machined into pre-stressed regions 56 having deep compressive residual stresses imparted by a laser shock peening (LSP) process extending into the article but not necessarily entirely through the article or wall.

The present invention has been described in an illustrative manner. It is to be understood that the terminology which has been used is intended to be in the nature of words of description rather than of limitation. While there have been described herein, what are considered to be preferred and exemplary embodiments of the present invention, other modifications of the invention shall be apparent to those skilled in the art from the teachings herein and, it is, therefore, desired to be secured in the appended claims all such modifications as fall within the true spirit and scope of the invention.

Accordingly, what is desired to be secured by Letters Patent of the United States is the invention as defined and differentiated in the following claims:

What is claimed:

1. A method for laser shock peening an article, the method comprising:
laser shock peening a laser shock peening surface of the article and forming at least one pre-stressed region having deep compressive residual stresses imparted by the laser shock peening,
the pre-stressed region extending into the article from a laser shock peened surface formed by the laser shock peening, and
machining a feature into article in the pre-stressed region after the laser shock peening.

2. A method as claimed in claim 1, further comprising the machining including machining the feature entirely in the pre-stressed region after the laser shock peening.

3. A method as claimed in claim 1, further comprising using the laser shock peening to form the pre-stressed region completely between oppositely spaced apart sides of the article.

4. A method as claimed in claim 3, further comprising the machining including machining the feature entirely in the pre-stressed region after the laser shock peening.

5. A method as claimed in claim 4, further comprising the machining including machining the feature entirely through the pre-stressed region and completely between and through the spaced apart outer and inner sides of the article after the laser shock peening.

6. A method as claimed in claim 5, further comprising the machining the feature includes machining a hole.

7. A method as claimed in claim 5, further comprising the machining the feature includes machining a scallop.

8. A method as claimed in claim 1, further comprising:
performing the laser shock peening on the laser shock peening surface on an arcuate wall of the article,
the wall having a radius of curvature, and
machining the feature including a centerline into wall with the centerline substantially parallel to the radius of curvature.

9. A method as claimed in claim 8, further comprising the machining including machining the feature entirely in the pre-stressed region after the laser shock peening.

10. A method as claimed in claim 8, further comprising using the laser shock peening to form the pre-stressed region completely between spaced apart outer and inner sides of the article.

11. A method as claimed in claim 10, further comprising the machining including machining the feature entirely in the pre-stressed region after the laser shock peening.

12. A method as claimed in claim 11, further comprising the machining including machining the feature entirely through the pre-stressed region and completely between and through the spaced apart outer and inner sides of the article after the laser shock peening.

13. A method as claimed in claim 12, further comprising the machining the feature includes machining a hole.

14. A method as claimed in claim 12, further comprising the machining the feature includes machining a hole having a curved sharp edge.

15. A method as claimed in claim 12, further comprising the machining the feature includes machining a scallop.

16. A method as claimed in claim 12, further comprising the machining the feature includes machining a scallop having a curved sharp edge.

17. A method as claimed in claim 3, further comprising the laser shock peening including simultaneously laser shock peening the oppositely spaced apart sides and forming the pre-stressed region therebetween.

18. A method as claimed in claim 1, further comprising:
the laser shock peening including simultaneously laser shock peening oppositely spaced apart outer and inner sides and forming the pre-stressed region completely therebetween,
performing the laser shock peening on the laser shock peening surface on an arcuate wall of the article,
the wall having a radius of curvature, and
machining the feature including a centerline into wall with the centerline substantially parallel to the radius of curvature.

19. A method as claimed in claim 18, further comprising the machining including machining the feature entirely in the pre-stressed region after the laser shock peening.

20. A method as claimed in claim 18, further comprising the machining including machining the feature entirely through the pre-stressed region and completely between and through the spaced apart outer and inner sides of the article after the laser shock peening.

21. A method as claimed in claim 20, further comprising the machining the feature includes machining a hole.

22. A method as claimed in claim 20, further comprising the machining the feature includes machining a hole having a curved sharp edge.

23. A method as claimed in claim 20, further comprising the machining the feature includes machining a scallop.

24. A method as claimed in claim 23, further comprising the machining the feature includes machining a scallop having a curved sharp edge.

25. A laser shock peened article comprising:
at least one pre-stressed region having deep compressive residual stresses imparted by laser shock peening,
the pre-stressed region extending into the article from a laser shock peened surface formed by the laser shock peening, and
a feature machined into the article in the pre-stressed region after the pre-stressed region was formed by the laser shock peening.

26. An article as claimed in claim 25, further comprising the feature disposed entirely in the pre-stressed region.

27. An article as claimed in claim 25, further comprising using the pre-stressed region extending completely between oppositely spaced apart sides of the article.

28. An article as claimed in claim 25, further comprising the feature extending entirely through the pre-stressed region and completely between and through the spaced apart outer and inner sides of the article.

29. An article as claimed in claim 28, further comprising the feature being a hole or a scallop.

30. An article as claimed in claim 25, further comprising:
an arcuate wall of the article,
the wall having a radius of curvature, and
the feature including a centerline machined into the wall and the centerline substantially parallel to the radius of curvature.
